(19) United States
(12) Patent Application Publication
(10) Pub. No.: US 2007/0145140 A1
(43) Pub. Date: Jun. 28, 2007

(54) Barcode

(75) Inventors: Kazuo Yoshimura, Rochester, MI (US); Mark C. Woydick, Orion, MI (US); William E. Bostick, Saint Clair, MI (US); Larry M. Wilmot, Oxford, MI (US)

Correspondence Address: FOLEY AND LARDNER LLP;SUITE 500, 3000 K STREET NW, WASHINGTON, DC, 20007, US

(73) Assignee: TK HOLDINGS, INC.

(21) Appl. No.: 11/635,764

(22) Filed: Dec. 8, 2006

Related U.S. Application Data
(60) Provisional application No. 60/748,581, filed on Dec. 9, 2005.

(51) Int. Cl. G06K 7/10

(52) U.S. Cl. 235/462.01

(57) ABSTRACT

A barcode system includes an apparatus with a first subcomponent and a second subcomponent. The first subcomponent has a first barcode portion, and the second subcomponent has a second barcode portion. When the first subcomponent is correctly assembled with the second subcomponent, the first barcode portion is correctly aligned with the second barcode portion, such that a readable barcode is formed by the first and second barcode portions. The barcode system also includes a scanner for reading the readable barcode formed by the first and second barcode portions. The scanner may be connected to a display to display output from the scanner.

### CROSS-REFERENCE TO RELATED PATENT APPLICATIONS

This application claims priority to U.S. Provisional Patent Application No. 60/748,581 filed Dec. 9, 2005, which is incorporated herein by reference in its entirety.

### BACKGROUND

The invention relates to a method of confirming correct assembly of components. More specifically, the invention relates to locating sections of a barcode on components of an apparatus and a method of confirming correct installation and/or mating of the components.

Conventionally, for assembly of electrical components, a simple continuity check can be performed to test the assembly and log the proper assembly of the electrical components/circuit. However, for non-electrical (i.e. mechanical) components, another means is required for confirmation.

One conventional method is by visual inspection or by listening for an audible “click” or other appropriate noise that indicates correct alignment and assembly. However, in some situations, a visual or audio inspection is not sufficient and unrealistic due to working conditions. Highly automated worksites, such as, for example, automobile assembly lines, can be noisy and poorly lit, thereby make a human visual or audio inspection difficult.

### SUMMARY

One embodiment relates to an apparatus in which proper assembly of subcomponents forming the apparatus can be confirmed. The apparatus comprises a first subcomponent including a first barcode portion and a second subcomponent including a second barcode portion. When the first subcomponent is correctly assembled with the second subcomponent, the first barcode portion is correctly aligned with the second barcode portion, such that a readable barcode is formed by the first and second barcode portions.

Another embodiment relates to a barcode system. The barcode system comprises an apparatus with a first subcomponent and a second subcomponent. The first subcomponent includes a first barcode portion. The second subcomponent includes a second barcode portion. When the first subcomponent is correctly assembled with the second subcomponent, the first barcode portion is correctly aligned with the second barcode portion, such that a readable barcode is formed by the first and second barcode portions. The barcode system further includes a scanner for reading the readable barcode formed by the first and second barcode portions. The barcode system also includes a display to display output from the scanner.

Yet another embodiment relates to a method of confirming correct assembly of subcomponents. The method comprises assembling a first subcomponent with a second subcomponent and forming a readable barcode. The readable barcode is formed by aligning a first barcode portion of the first subcomponent correctly with a second barcode portion of the second subcomponent, when the first and second subcomponents are correctly aligned.

Another embodiment provides an inflator assembly, in which proper assembly of components of the inflator assembly can be confirmed. The inflator assembly comprises an inflator connector component with a first barcode portion and an inflator tube component with a second barcode portion. When the inflator connector component is correctly assembled with the inflator tube component, the first barcode portion is correctly aligned with the second barcode portion, such that a readable barcode is formed by the first and second barcode portions.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description and the accompanying exemplary embodiments shown in the drawings, which are briefly described below.

FIGS. 1(a), 1(b) and 1(c) illustrate a two-piece barcode arranged on two separate subcomponent parts according to an embodiment. FIG. 1(a) illustrates the subcomponent parts when separated. FIG. 1(b) illustrates the subcomponent parts incorrectly mated. FIG. 1(c) illustrates the subcomponent parts when correctly assembled.

FIGS. 2(a), 2(b) and 2(c) illustrate a two-piece barcode arranged on two separate subcomponent parts to confirm the accuracy of installation of three separate subcomponent parts, according to another embodiment. FIG. 2(a) illustrates the subcomponent parts when separated. FIG. 2(b) illustrates the subcomponent parts incorrectly assembled together. FIG. 2(c) illustrates the subcomponent parts when correctly assembled together.

FIGS. 3(a), 3(b) and 3(c) illustrate a two-piece barcode arranged on two separate subcomponent parts to confirm the accuracy of installation of four separate subcomponent parts, according to another embodiment. FIG. 3(a) illustrates the subcomponent parts when separated. FIG. 3(b) illustrates the subcomponent parts incorrectly assembled together. FIG. 3(c) illustrates the subcomponent parts when correctly assembled together.

FIGS. 4(a) and 4(b) illustrate a three-piece barcode arranged on three separate subcomponent parts to confirm the accuracy of installation of the three subcomponents, according to another embodiment. FIG. 4(a) illustrates the subcomponents when separated. FIG. 4(b) illustrates the subcomponents when correctly assembled together.

FIG. 5 illustrates a schematic view of a barcode system in which a scanner and display are shown.

FIGS. 6(a)-6(c) illustrate an inflator assembly with a two-piece barcode according to another embodiment. FIG. 6(a) illustrates an inflator connector component and an inflator tube component of the inflator assembly prior to being assembled together. FIG. 6(b) illustrates the inflator assembly correctly assembled together and forming a readable barcode with correct alignment of first and second barcode portions. FIG. 6(c) illustrates an incorrect assembly of the inflator components, such that the readable barcode is not formed.

### DETAILED DESCRIPTION

An object of an embodiment is to provide an electronic confirmation that two or more non-electrical components of a product have been correctly assembled. The electric confirmation of components that have been properly assembled can increase the speed and accuracy

However, in some situations, a visual or audio inspection is not sufficient and unrealistic due to working conditions. Highly automated worksites, such as, for example, automobile assembly lines, can be noisy and poorly lit, thereby make a human visual or audio inspection difficult.

According to embodiments, a single readable barcode that spans mating subcomponents. A portion of the barcode exists on part “A” and the balance of the barcode exists on part “B.” The barcode will only be read by a barcode scanning device when the components (A+B) are properly aligned and assembled. The electronic confirmation of the correct assembly can then be logged into a database by a scanner or other suitable device.

Reference will now be made in detail to exemplary embodiments, examples of which are illustrated in the accompanying drawings.

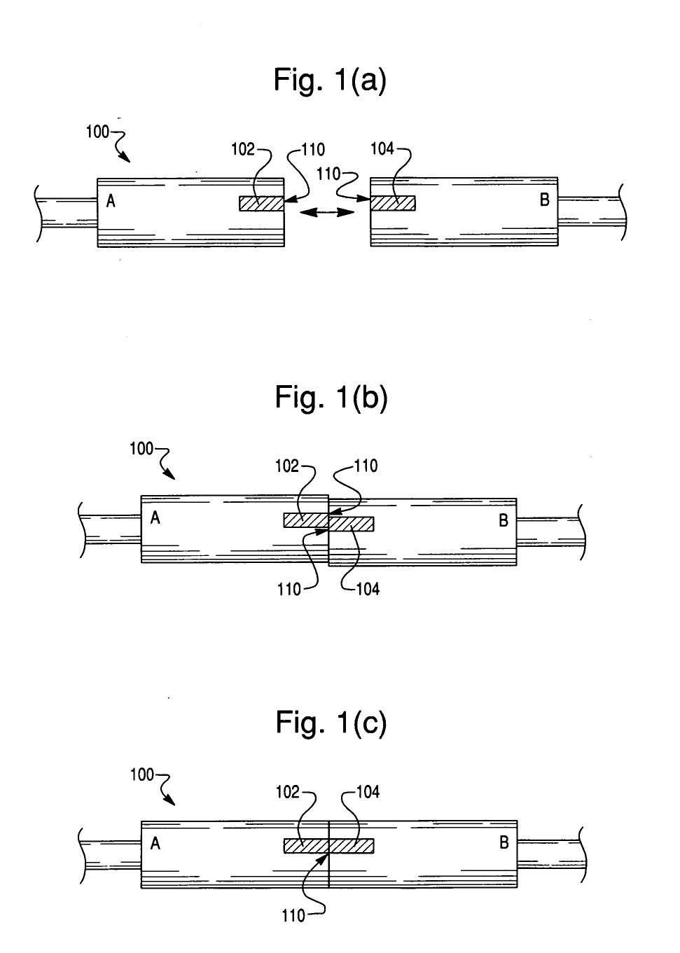

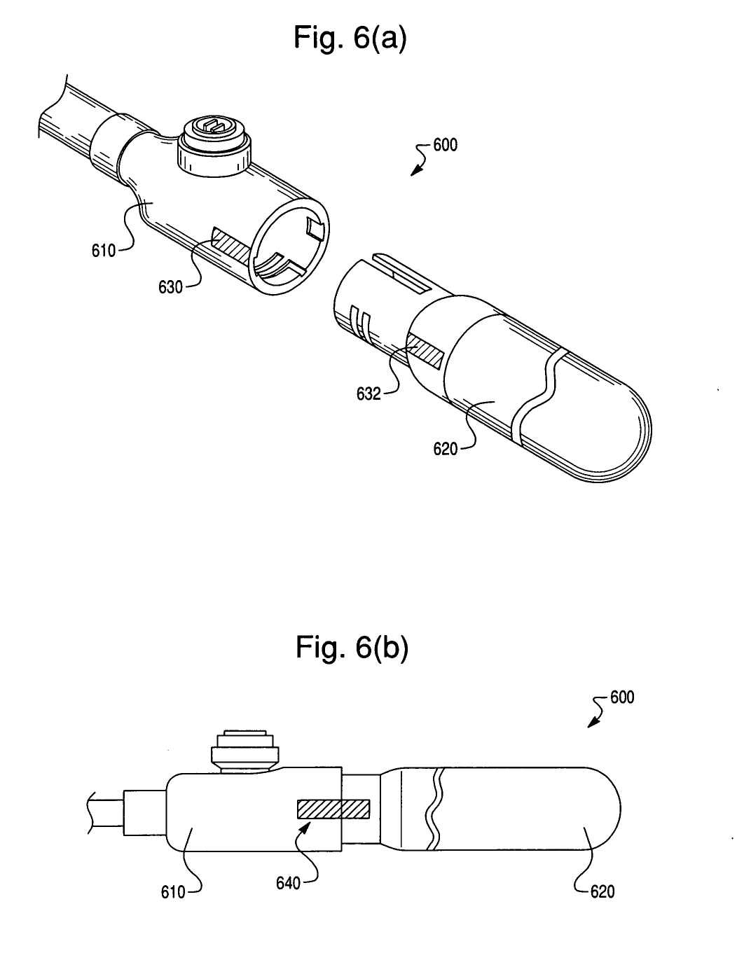

FIGS. 1(a), 1(b) and 1(c) illustrate a first embodiment. A product (sometimes referred to herein as a unit, module, or apparatus) 100 includes two components A, B which need to be aligned and assembled together. FIG. 1(a) illustrates the components A, B prior to assembly. The first component A includes a first half of the barcode 102. The second component B includes the remainder of the barcode 104. The barcode sections 102, 104 are attached to the components A, B, respectively, in such a manner that the components A, B must be assembled correctly in order for the code to be read by a barcode scanning device (shown in FIG. 5). Simply reading the information off of one component independently will not provide enough data for a logical scan by a barcode scanner. Further, if the components A, B are misaligned or are not fully engaged, the barcode scan will fail.

As shown in FIG. 1(b), component B is not correctly aligned with component A. The mating regions 110 of the barcodes are not correctly matched. Therefore, the first barcode section 102 does not align with the second barcode section 104, thus causing a failed barcode scan. However, as shown in FIG. 1(c), when the components A, B are properly aligned, thus ensuring that the mating regions 110 of the barcode sections 102, 104 are aligned, a proper barcode scan can occur.

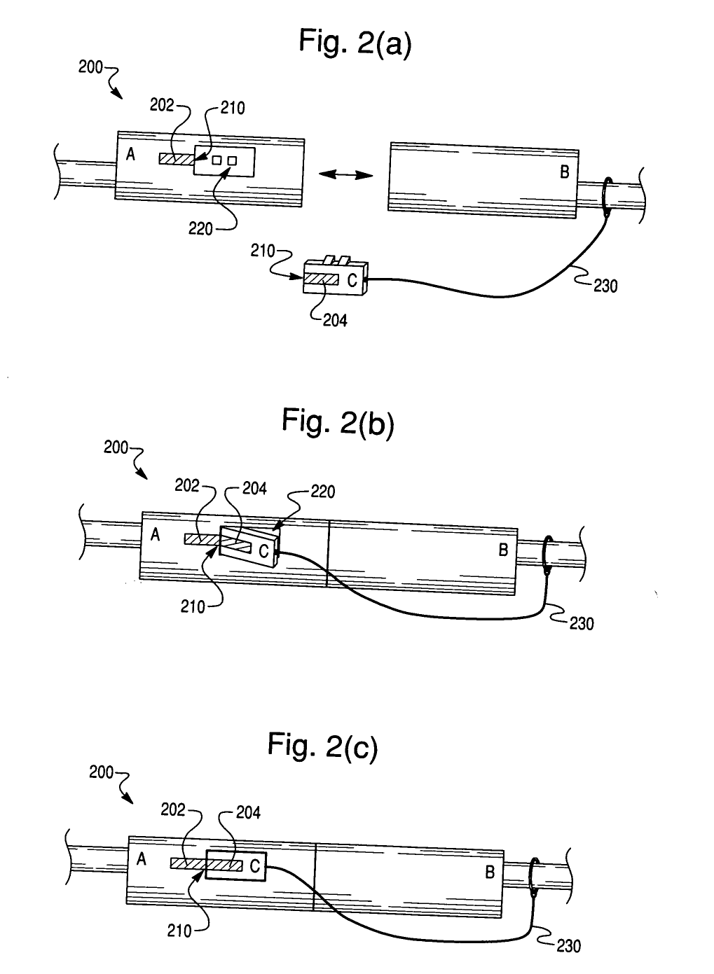

FIGS. 2(a), 2(b) and 2(c) illustrate another embodiment in which the barcode sections 202, 204 may be used to confirm the accurate assembly of three components A, B, C. FIG. 2(a) illustrates three components A, B, C prior to assembly. Component A includes the first section of the barcode 202 and component C includes the second section of the barcode 204.

As shown in FIG. 2(b), even if components A and B are properly aligned, but component C is not aligned correctly with component A, the mating regions 110 and, thus, the barcode sections 202, 204 will not be correctly aligned. In this circumstance, a barcode scan will fail. Component C is configured to attach to an attachment area 220 on component A. Component C is also attached by connection 230 to component B. If the components A, B and C are properly assembled, as shown in FIG. 2(c), component C fits correctly into attachment area 220 and the mating regions 210 of the barcode sections 202, 204 align, thus having the barcode sections 202, 204 align. A barcode scan will be successfully in this circumstance.

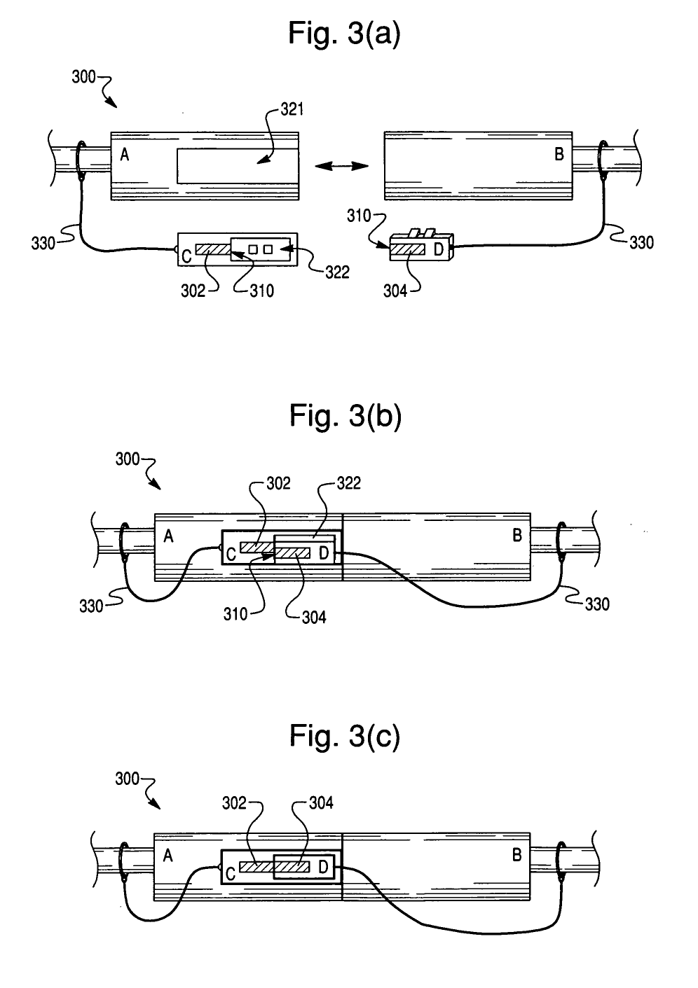

FIGS. 3(a), 3(b) and 3(c) illustrate another embodiment in which barcode sections 302 and 304 are configured to be aligned at the mating region 310 when the components A, B, C and D of the product 300 are properly assembled. FIG. 3(a) illustrates the product 300 prior to assembly. Component A is configured to mate with component B. Component A includes a first attachment area 321 for receiving component C. Component C includes a second attachment area 322 for receiving component D. Component C and component D each include a connection 330 for connecting the components C and D to components A and B, respectively. The first barcode section 302 is located on component C and the second barcode section 304 is located on component D.

FIG. 3(b) illustrates one exemplary way in which the components A, B, C and D are improperly assembled. In this circumstance, the mating regions 310 of the barcode sections 302, 304 do not align because component D is not properly assembled with component C. FIG. 3(c) illustrates proper assembly of the components A, B, C and D. As shown, the first barcode section 302 is aligns with the second barcode section 304, thus allowing for a successful barcode scan.

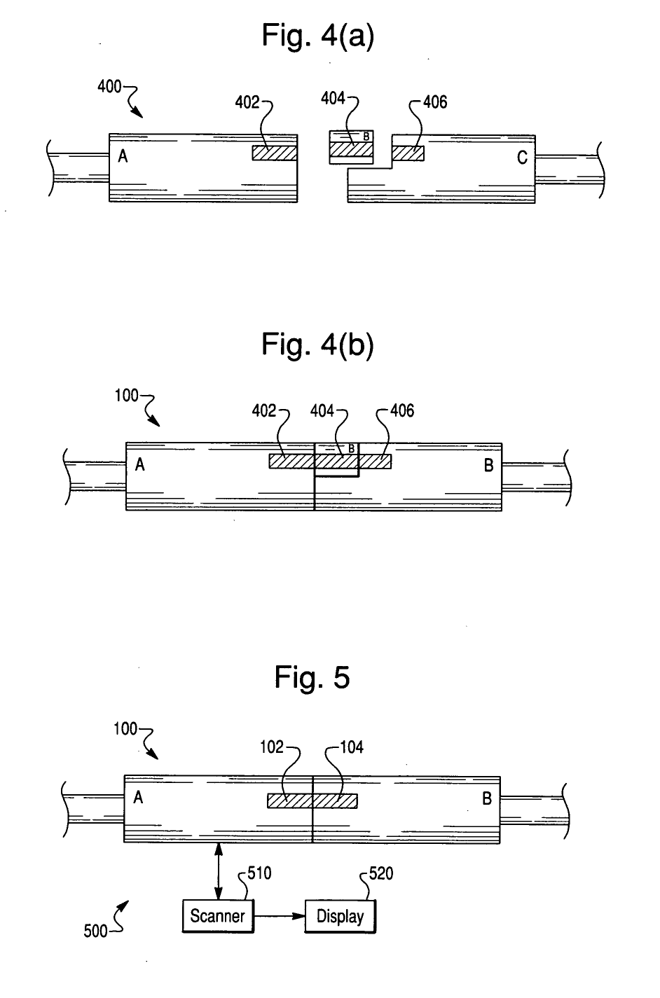

The barcode sections may be attached to components by permanent etching, adhesive labels, molds, or any other suitable manner. Further, if the mating components do not have sufficient space for a barcode section, the barcode section(s) can be written and/or attached to additional components, such as shown in FIGS. 2(a)-3(c). [0028] FIGS. 4(a) and 4(b) illustrate another embodiment in which a readable barcode is formed on a product by three separate barcode portions 402, 404, 406. FIG. 4(a) illustrates three separate components A, B, C prior to assembly. Each component A, B, C include a barcode portion, 402, 404, 406, respectively. FIG. 4(b) illustrates the product 400 after correct assembly of all three components A, B, C. Each barcode portion 402, 404, 406 is correctly aligned with each other such that the readable barcode is formed.

FIG. 5 illustrates an exemplary barcode system 500 in which a product 100 with barcode sections 102, 104 are used in conjunction with a scanner 510 and a display 520. In the system 500, the scanner 510 is capable of reading the readable barcode formed by the correct alignment of the barcode sections 102, 104. The scanner 510 may be linked, or otherwise connected, to the display 520, such that the output of the scanner 510 is then displayed on the display 520. The scanner 510 may be any type of suitable barcode scanner. The display 520 may be a digital, audio, or any other suitable type of display.

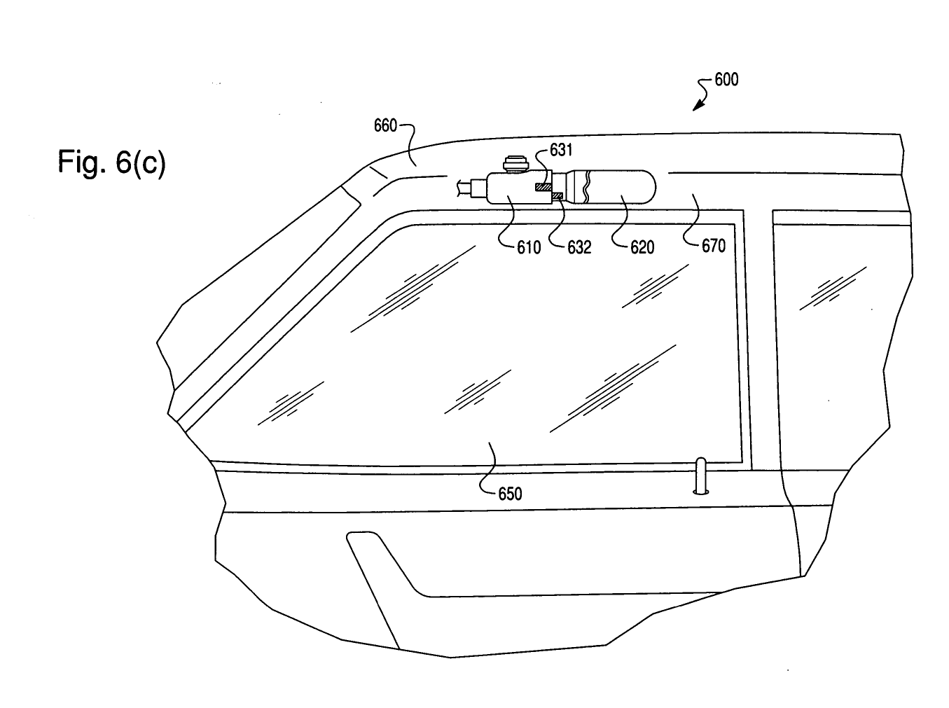

FIGS. 6(a)-6(c) illustrate an exemplary inflator assembly 600. The inflator assembly 600 includes an inflator connector component 610 and an inflator tube component 620. Each component 610, 620 includes a separate barcode portion 631, 632. For example, the inflator connector component 610 includes a first barcode portion 631 and the inflator tube component 620 includes a second barcode portion 632. FIG. 6(a) illustrates the components 610, 620 prior to being assembled together.

If the inflator connector component 610 is properly assembled with the inflator tube component 620, the first barcode portion 631 will align properly with the second barcode portion 632, such that the barcode portions 631, 632 form a readable barcode 640. The readable barcode 640 is capable of being scanned or read by a suitable barcode scanner in order to confirm correct assembly of the inflator components 610, 620, such as shown in FIG. 5. FIG. 6(b) illustrates a readable barcode 640. FIG. 6(c) illustrates the inflator assembly 600 when the assembly 600 is incorrectly assembled together, such that the second barcode portion 632 does not align with the first barcode portion 631. In such a circumstance, a barcode scanner would not be able to read the barcode 640, thus acting as a warning that the components 610, 620 are incorrectly assembled.

The readable barcode 640 that is formed by separate portions 631, 632 located on separate inflator components 610, 620 allows an original equipment manufacturer (“OEM”) to install inflator components that are manufactured either by a third party, or by the OEM, and to snap (or otherwise join) the components together. If separate inflator components are used to form an assembly, it can reduce costs for shipping, manufacturing, and/or storing of components at the OEM. Furthermore, reading a readable barcode 640 can permit an OEM to install components faster and more accurately. Occasionally, inflator components of an assembly can be installed in a twisted or otherwise incorrect manner that is not readily apparent to an automotive assembly line worker. If an OEM did not have a readable barcode formed on two separate components, the OEM may take a longer time to confirm the accuracy of the assembly and/or the assembly may not be checked, thus resulting in possibly incorrect inflator assembly.

It will be recognized that the inflator assembly 600 shown is exemplary only and other components of an inflator assembly and/or airbag assembly may be used with separate barcode components forming a readable barcode. Furthermore, the inflator components 610, 620 may be metal, plastic, or any other suitable material. For further example, the readable barcode 640 may be formed by being separated into three or more portions that are located on three or more separate components of an inflator and/or airbag assembly.

According to another embodiment, the inflator assembly 600 can be installed in a vehicle. The readable barcode may be formed with the inflator assembly is correctly installed in the vehicle. For example, different components of the inflator assembly may include separate barcode portions that will be correctly aligned if the inflator assembly is correctly assembled in the vehicle. Alternatively, a portion of the vehicle may include a barcode portion that will form a readable barcode when an inflator assembly and/or airbag assembly is properly assembled in the vehicle.

According to embodiments, the barcode portions may be etched, embedded, attached, or connected, or located on components in any other suitable manner.

It will be recognized that an advantage of an embodiment is the ability to make a positive confirmation and electronically data-log that two or more mating connectors or subcomponents have been properly connected. Embodiments may be of low cost

It will be recognized that the barcode may be divided into a plurality of parts, not just two. For example, the barcode may be divided into three, four or any other suitable number of parts. Further, it will be recognized that the divided barcode, regardless of the number of barcode parts, may be used to confirm the accuracy of mating of any number of parts of a product. For example, FIGS. 1(a)-1(c) illustrate the mating of two parts of a product and FIGS. 3(a)-3(c) illustrate the mating of four parts of a product. Alternatively, the barcode can be used to confirm the accuracy of any number of parts of a product, such as, for example, five, six, seven, or any other suitable number.

Furthermore, it will be recognized that the drawings are exemplary only. The products and components may be any suitable type of mating components, with any suitable shape, size, or configuration.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An apparatus in which proper assembly of subcomponents forming the apparatus can be confirmed, comprising:
a first subcomponent including a first barcode portion; and
a second subcomponent including a second barcode portion,
wherein, when the first subcomponent is correctly assembled with the second subcomponent, the first barcode portion is correctly aligned with the second barcode portion, such that a readable barcode is formed by the first and second barcode portions.

2. The apparatus of claim 1, further comprising a third subcomponent with a third barcode portion, and wherein when the third subcomponent is correctly assembly with the first and second subcomponents, the third barcode portion is correctly aligned with the first and second barcode portions, such that the readable barcode is formed by the first, second, and third barcode portions.

3. The apparatus of claim 1, further comprising a third subcomponent, and wherein the readable barcode is formed by correct alignment of the first and second barcode portions when the first, second, and third subcomponents are correctly assembled.

4. The apparatus of claim 1, wherein the first and second subcomponents are non-electrical.

5. A barcode system, comprising:
an apparatus with a first subcomponent and a second subcomponent, the first subcomponent including a first barcode portion, and the second subcomponent including a second barcode portion, wherein, when the first subcomponent is correctly assembled with the second subcomponent, the first barcode portion is correctly aligned with the second barcode portion, such that a readable barcode is formed by the first and second barcode portions;
a scanner for reading the readable barcode formed by the first and second barcode portions; and
a display to display output from the scanner.

6. The system of claim 5, further comprising a third subcomponent with a third barcode portion, and wherein when the third subcomponent is correctly assembly with the first and second subcomponents, the third barcode portion is correctly aligned with the first and second barcode portions, such that the readable barcode is formed by the first, second, and third barcode portions.

7. The system of claim 5, further comprising a third subcomponent, and wherein the readable barcode is formed by correct alignment of the first and second barcode portions when the first, second, and third subcomponents are correctly assembled.

8. The system of claim 5, wherein the first and second subcomponents are non-electrical.

9. A method of confirming correct assembly of subcomponents, comprising:
assembling a first subcomponent with a second subcomponent; and
forming a readable barcode by aligning a first barcode portion of the first subcomponent correctly with a second barcode portion of the second subcomponent when the first and second subcomponents are correctly aligned.

10. The method of claim 9, further comprising:
reading the readable barcode with a scanner; and
displaying output from the scanner in a display.

11. An inflator assembly in which proper assembly of components of the inflator assembly can be confirmed, comprising:
an inflator connector component with a first barcode portion; and
an inflator tube component with a second barcode portion,
wherein, when the inflator connector component is correctly assembled with the inflator tube component, the first barcode portion is correctly aligned with the second barcode portion, such that a readable barcode is formed by the first and second barcode portions.

12. The inflator assembly of claim 11, further comprising a scanner to read the readable barcode formed by correct alignment of the first and second barcode portions.
